(19) United States
(12) Patent Application Publication
(10) Pub. No.: US 2009/0189952 A1
(43) Pub. Date: Jul. 30, 2009

(54) APPARATUS FOR JETTING DROPLETS USING SUPER-HYDROPHOBIC NOZZLE

(75) Inventors: Young Jong Lee, Seoul (KR); Do Young Byun, Seoul (KR)

Correspondence Address: ADAM K. SACHAROFF;MUCH SHELIST DENENBERG AMENT & RUBENSTEIN, 191 N. WACKER DRIVE, Suite 1800, CHICAGO, IL, 60606-1615, US

(73) Assignee: Konkuk University Industrial Cooperation Corp., Seoul (KR)

(21) Appl. No.: 12/039,881

(22) Filed: Feb. 29, 2008

(30) Foreign Application Priority Data
Jan. 28, 2008 (KR) 10-2008-0008416

(51) Int. Cl. B41J 2/135

(52) U.S. Cl. 347/45

(57) ABSTRACT

Disclosed is an apparatus for jetting droplets using a super-hydrophobic nozzle, including a body having a chamber formed in the body to receive a predetermined amount of fluid containing liquid and particles and a nozzle formed in the side face of the body while communicating with the chamber to jet the fluid, and an actuator for generating an electric field for jetting the fluid through the nozzle, the side face of the body being of super-hydrophobic, and the actuator including an electrode located in the chamber or the nozzle or deposited on the wall surface thereof, an electrode plate spaced apart from the side face of the body at a predetermined distance with a jetting hole at a position corresponding to the nozzle, a power supply portion for applying voltage between the electrode and the electrode plate, and a control portion for controlling the power supply portion, thereby effectively realizing the initial formation of the meniscus of the fluid upon jetting through the super-hydrophobic nozzle, and increasing stability and efficiency of the jetting even upon repeated jetting.

### BACKGROUND OF THE INVENTION

1. Field of the Invention

The present invention relates, generally, to an apparatus for jetting droplets using a super-hydrophobic nozzle, and more particularly, to an apparatus for jetting droplets using a super-hydrophobic nozzle, in which an electrostatic field is applied to the surface of a fluid to be jetted through the nozzle, so that the fluid is efficiently jetted in the form of droplets.

2. Description of the Related Art

Typically, MEMS (Microelectromechanical System)/NEMS (Nanoelectromechanical System) techniques based on semiconductor processes for use in the fabrication of highly integrated fine structures are conducted through lamination and etching using a chemical reaction, and suffer from the disadvantages of the discharge of hazardous materials, such as etchants, reactive gases, and reaction remnants.

Inkjet printer head techniques are expected to be applicable in various fields. In order to overcome the above problems, the inkjet printer head technique is applied to the semiconductor fabrication process in the IT field, such that only a desired portion is selectively patterned to thus decrease somewhat the discharge of hazardous materials.

In particular, with the great advancement of flat panel displays, the size of the display industry market is drastically growing. As the display industry has strongly trended toward a decrease in prices along with lightweight, slimness, and size increases from technical standpoints, inkjet printer head techniques, capable of drastically reducing the process thereof compared to conventional semiconductor process techniques, are recognized as novel technology for assuring marketability and competitiveness. Hence, thorough research thereon is being conducted.

The application scope of the inkjet printer head techniques, including not only display industries but also various micro sensors, biochips, RFID, micro multilayered antennas, and biological cell incubators, is gradually broadening.

As mentioned above, the inkjet printer head technique for jetting a fluid in a droplet form using an electrostatic field has been variously applied to coatings or the formation of particles, and furthermore, to mass spectrometry for the analysis of proteins.

Recently, as bio-related industries are regarded as increasingly important, the demand for related mass spectrometry is increasing. In particular, due to the requirement for delicate protein sample analysis, mass spectrometry for analyzing a sample on the molecular scale is being studied.

For mass spectrometry, electrospray ionization (ESI) should be effectively conducted. To this end, nozzles and apparatuses having various forms are developed.

Conventional techniques have been developed such that the size of the nozzle or tip is decreased to the nanometer scale to jet small droplets, or a multiple nozzle is devised, but a nozzle having a protruding structure for stable spraying or droplet jetting is still required.

However, the protruding nozzle on the nanometer scale is disadvantageous because such a nozzle is difficult to manufacture and is also very difficult to realize in an apparatus on the nanometer scale, and thus a novel approach thereto is needed.

Moreover, most apparatuses are fabricated using silicon or quartz capillaries, and thus, there is a need for the development of an apparatus using a simpler polymer.

### SUMMARY OF THE INVENTION

Accordingly, the present invention has been made keeping in mind the problems encountered in the related art, and the present invention provides an apparatus for jetting droplets using a super-hydrophobic nozzle, which effectively realizes the initial formation of the meniscus of a fluid containing liquid and particles at the time of jetting through the nozzle, and causes no changes in the initial shape or position of the meniscus by repeated jetting, thus realizing stable jetting.

According to the present invention, an apparatus for jetting droplets using a super-hydrophobic nozzle is provided, which comprises a body including a chamber formed in the body to receive a predetermined amount of fluid containing liquid and particles and a nozzle formed in the side face of the body while communicating with the chamber to jet the fluid containing liquid and particles, and an actuator for generating an electric field so that the fluid containing liquid and particles is jetted through the nozzle, wherein the side face of the body is of super-hydrophobic.

The body may be formed of PTFE, and the side face of the body may be formed into a super-hydrophobic surface through an oxygen plasma process or an argon and oxygen ion beam process.

The side face of the body may be coated with Teflon, and the side face of the body, coated with Teflon, may be formed into a super-hydrophobic surface through an oxygen plasma process or an argon and oxygen ion beam process.

The side face of the body may be coated with a PTFE solution, and the side face of the body, coated with the PTFE solution, may be formed into a super-hydrophobic surface through an oxygen plasma process or an argon and oxygen ion beam process.

The side face of the body may include a plurality of nozzles formed therein, which communicates with a plurality of chambers formed in the body, respectively.

The actuator may comprise an electrode located in the chamber or the nozzle or deposited on the wall surface thereof, an electrode plate spaced apart from the side face of the body at a predetermined distance and having a jetting hole at a position corresponding to the nozzle, a power supply portion for applying voltage between the electrode and the electrode plate, and a control portion for controlling the power supply portion.

The electrode plate may include a plurality of electrode plates, which is disposed parallel to each other, and the nozzle may include a plurality of nozzles, which is independently controlled to form and jet the droplets.

A drop-on-demand inkjet apparatus using the above apparatus is provided, which is adapted to jet droplets at various time points at various frequencies in response to application of a pulse voltage signal.

A thrust apparatus using the above apparatus is provided.

An ESI apparatus using the above apparatus is provided, which is adapted for mass spectrometry.

In addition, an apparatus for jetting droplets using a super-hydrophobic nozzle is provided, which comprises a body including a chamber formed in the body to receive a predetermined amount of fluid containing liquid and particles and a nozzle formed in the side face of the body while communicating with the chamber to jet the fluid containing liquid and particles, and an actuator for generating an electric field so that the fluid containing liquid and particles is jetted through the nozzle, wherein the side face of the body is of super-hydrophobic, and the actuator comprises an electrode located in the chamber or the nozzle or deposited on the wall surface thereof, an electrode plate spaced apart from the side face of the body at a predetermined distance and having a jetting hole at a position corresponding to the nozzle, a power supply portion for applying voltage between the electrode and the electrode plate, and a control portion for controlling the power supply portion.

### BRIEF DESCRIPTION OF THE DRAWINGS

These features and other advantages of the present invention will be more clearly understood from the following detailed description taken in conjunction with the accompanying drawings, in which:

FIG. 1 is a schematic perspective view illustrating an apparatus for jetting droplets using a super-hydrophobic nozzle according to a first embodiment of the present invention;

FIG. 2 is a perspective view of FIG. 1, which shows a longitudinal section thereof;

FIG. 3 is a schematic cross-sectional view illustrating the apparatus for jetting droplets using a super-hydrophobic nozzle according to the first embodiment of the present invention;

FIG. 4 is a schematic cross-sectional view illustrating an apparatus for jetting droplets using a super-hydrophobic nozzle according to a second embodiment of the present invention;

FIG. 5 is a schematic perspective view illustrating an apparatus for jetting droplets using a super-hydrophobic nozzle according to a third embodiment of the present invention;

FIG. 6 is a schematic view illustrating an ion beam process apparatus for forming the super-hydrophobic surface of the apparatus for jetting droplets using the super-hydrophobic nozzle according to the present invention;

FIG. 7 is photographs illustrating the contact angle, observed using a CCD camera after dropping 2 μl of deionized water on the surface of PTFE which is subjected to an ion beam process under conditions of 2 sccm of argon, 3 sccm of oxygen, and 1 keV;

FIG. 8 is a graph illustrating the data of FIG. 7;

FIG. 9 is a table illustrating the changes in contact angle; and

FIG. 10 is photographs illustrating the formation of a meniscus under the conditions according to the present invention.

### DESCRIPTION OF THE PREFERRED EMBODIMENTS

Hereinafter, a detailed description will be given of the present invention, with reference to the appended drawings.

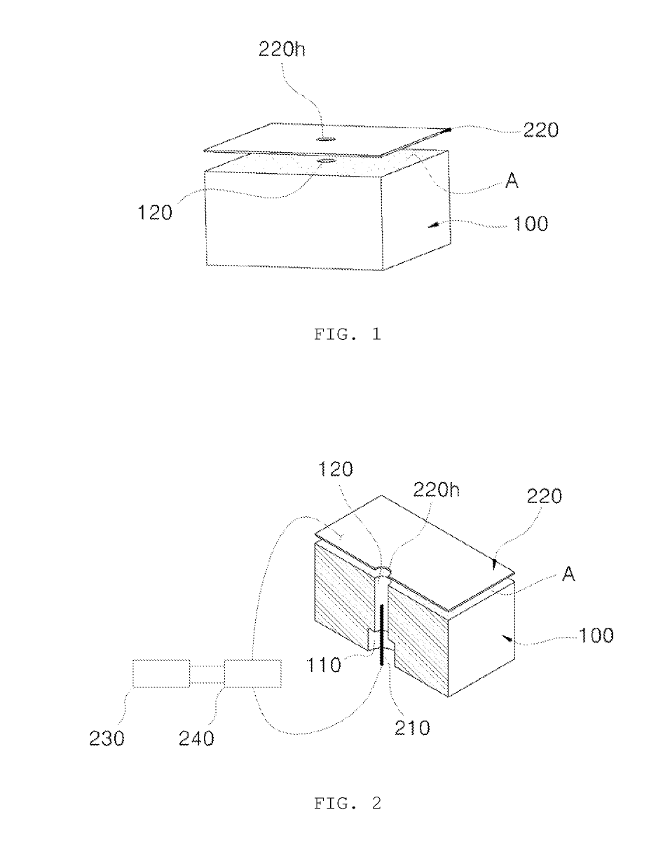

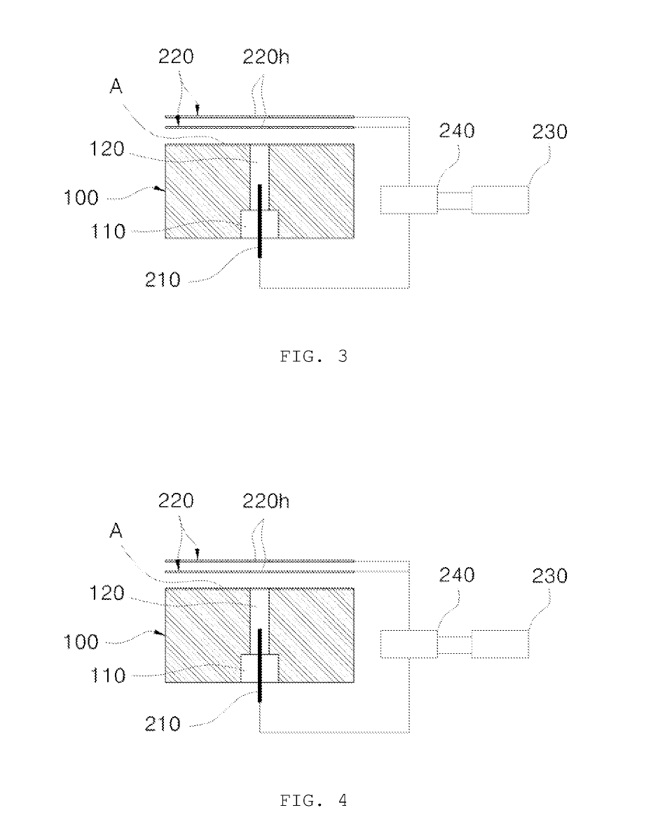

According to the present invention, an apparatus for jetting droplets using a super-hydrophobic nozzle 120 comprises a body 100 including a chamber 110 and the nozzle 120, and an actuator for generating an electrostatic field so that a fluid is jetted through the nozzle 120 of the body 100, as illustrated in FIGS. 1 and 2.

The chamber 110 of the body 100 is a predetermined space defined in the body 100 in order to receive a predetermined amount of fluid, containing liquid and particles, and the nozzle 120 of the body 100 is provided in the form of a hole in a side face A of the body 100 while communicating with the chamber 110 in order to jet the fluid containing liquid and particles received in the chamber 110.

The chamber 110 and the nozzle 120 may include a plurality of chambers 110 and a plurality of nozzles 120 communicating with the respective chambers 110, as seen in FIG. 5. In this way, when the pluralities of chambers 110 and nozzles 120 are formed, different types of fluid are received in the respective chambers 110 which is advantageous.

The actuator plays a role in generating an electrostatic field so that the fluid containing liquid and particles received in the chamber 110 is jetted through the nozzle 120, and specifically includes an electrode 210 located in the chamber 110 or nozzle 120, an electrode plate 220 spaced apart from the side face A of the body 100 at a predetermined distance and having a jetting hole 220h at a position corresponding to the nozzle 120, a power supply portion 230 for applying voltage between the electrode 210 and the electrode plate 220, and a control portion 240 for controlling the power supply portion 230.

In addition, the electrode 210 may be formed on the wall surface of the chamber 110 or nozzle 120 through deposition.

In the actuator thus constructed, a positive pole is connected to the electrode 210 and a negative pole is connected to the electrode plate 220, after which voltage is applied between the electrode 210 and the electrode plate 220 using the power supply portion 230, thereby jetting the fluid containing liquid and particles from the chamber 110 of the body 100 toward the electrode plate 220 through the nozzle 120 of the body 100 by electric spray, and also jetting the fluid jetted toward the electrode plate 220 through the jetting hole 220h.

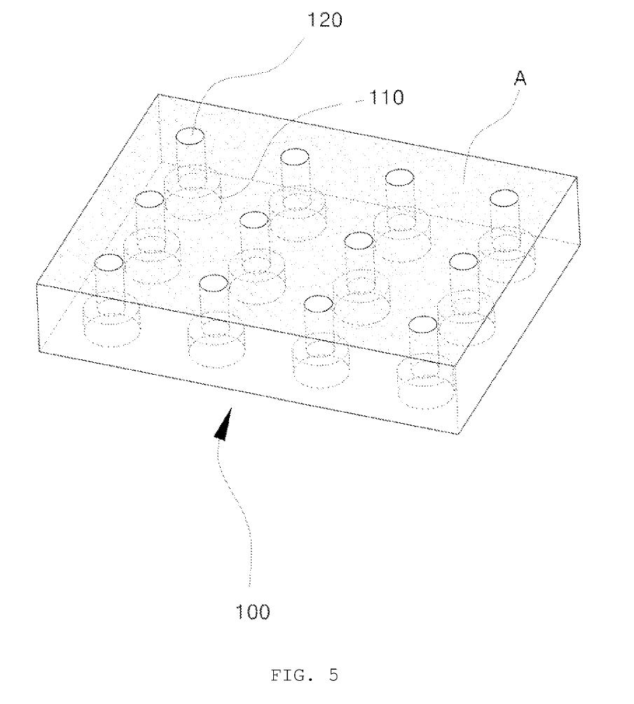

As illustrated in FIGS. 1 to 5, the side face A of the body 100, that is, the side face A to which the end of the nozzle 120 communicating with the chamber 110 is located, is of super-hydrophobic.

For example, the body 100 is formed of PTFE (polytetrafluoroethylene), and the side face A of the body 100 may be formed into a super-hydrophobic surface A through an oxygen plasma process or an argon and oxygen ion beam process.

In addition, the side face A of the body 100 may be coated with Teflon, and the side face A of the body 100, coated with Teflon, may be formed into a super-hydrophobic surface A through an oxygen plasma process or an argon and oxygen ion beam process.

In addition, the side face A of the body 100 may be coated with a PTFE solution, and the side face A of the body 100, coated with the PTFE solution, may be formed into a super-hydrophobic surface A through an oxygen plasma process or an argon and oxygen ion beam process.

In addition to the above three methods, any method may be used, as long as it enables the formation of the side face A of the body 100 into the super-hydrophobic surface A.

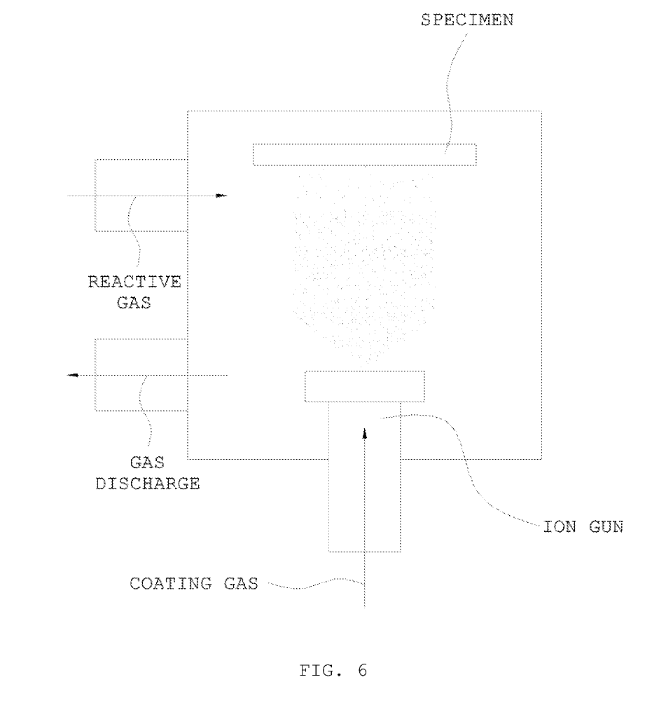

The formation of the side face A of the body 100 into the super-hydrophobic surface A through an oxygen plasma process or an argon and oxygen ion beam process may be realized using an ion beam process apparatus as seen in FIG. 6, in which a specimen designates the body 100.

The apparatus for jetting droplets using the super-hydrophobic nozzle 120 may be incorporated in a DOD (drop-on-demand) inkjet apparatus for jetting droplets at various time points at various frequencies in response to the application of a pulse voltage signal. In addition to the DOD inkjet apparatus, the apparatus according to the present invention may be incorporated in a thrust apparatus or an ESI apparatus for mass spectrometry.

### Experimental Example 1

A PTFE polymer having a thickness of 3 mm and a width and a length of 1.5 cm was processed and prepared.

A side face of the PTFE thus prepared was subjected to super-hydrophobic treatment using an ion beam process apparatus of FIG. 6, under conditions of 2 sccm (standard cubic centimeters per minute) of argon, 3 sccm of oxygen, and 1 keV. Further, the process was conducted while the process time was variously changed to 30 sec, 120 sec, 300 sec, and 480 sec.

Changes in contact angle depending on the ion beam process time were determined in a manner such that a contact angle measurement system was constructed using an X-Y stage, a CCD camera, and a microlens, the volume of droplets of deionized (DI) water was set to 2 μl using a micro pipette, and then contact angle measurement was conducted. The contact angle was measured every 24 hours for one week, in order to observe the changes in contact angle depending on the time.

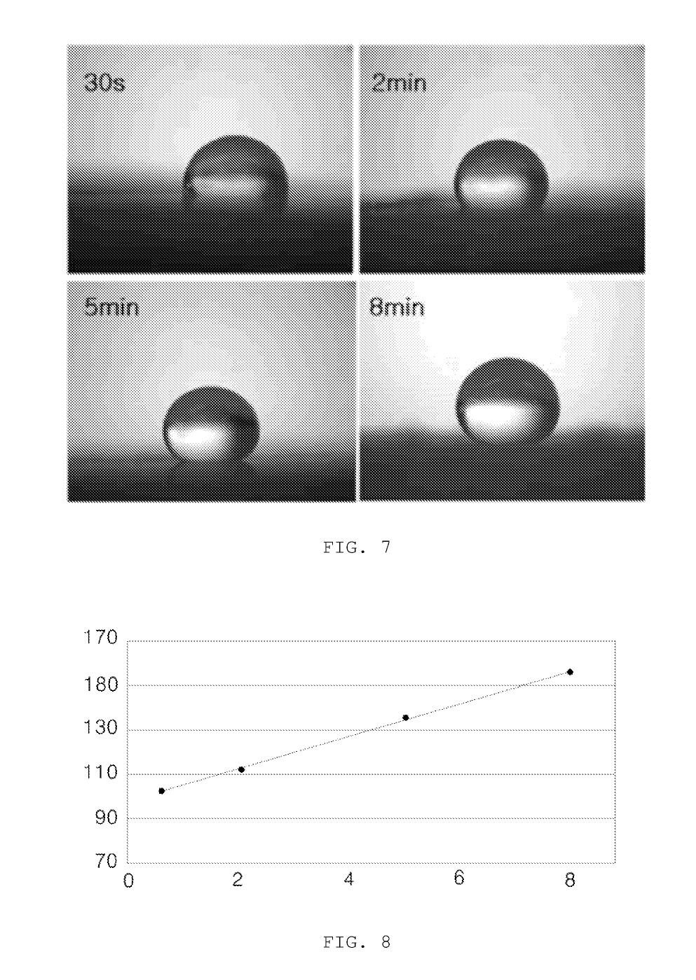

FIG. 7 is photographs showing the contact angle observed using a CCD camera after 2 μl of DI water is dropped on the surface of PTFE subjected to ion beam process treatment under conditions of 2 sccm of argon, 3 sccm of oxygen, and 1 keV.

As the results of measurement of the contact angle, the contact angle of DI water was measured to be 115° after 30 sec, 140° after 120 sec, 150° after 300 sec, and 155° after 480 sec.

This is explained as follows. That is, in the course of the ion beam process, although small droplets, not affected by gravity, are more greatly affected by surface tension between the droplets and the surface than by gravity, the PTFE surface is roughened due to the effect of ion beams and is thus imparted with super-hydrophobic surface properties, resulting in lower surface energy than before the ion beam process.

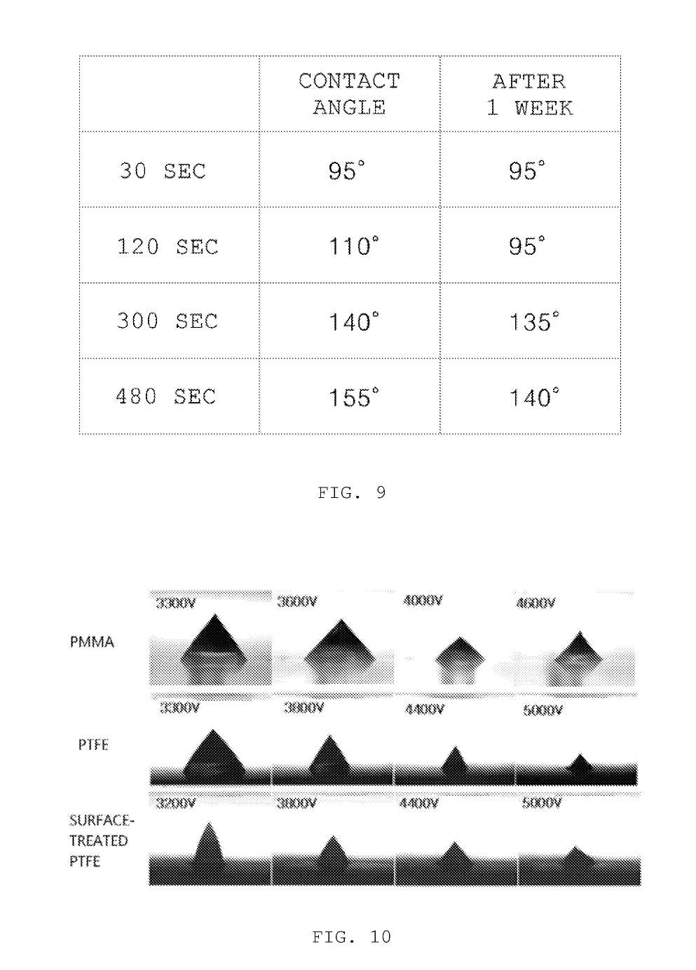

Further, the change in contact angle depending on time was determined in a manner such that the contact angle was measured every 24 hours for one week. As the results, almost no change in contact angle occurred under the above four process conditions (FIG. 9).

### Experimental Example 2

For a PMMA (polymethylmethacrylate) micro thrust apparatus, PMMA 8 mm thick was processed into a body having a width of 3 cm and a length of 3 cm, which was then processed to have a chamber having a diameter of 3 mm, using a laser process apparatus.

A positive electrode of electric wires having a diameter of 0.25 mm, and a negative electrode of aluminum having a thickness of 200 μm were connected to a high-voltage supply apparatus.

As a working fluid of the PMMA micro thrust apparatus, a mixture solution, comprising 50% DI water, 49% methanol (CH₃OH), and 1% acetone (CH₃COCH₃) was used. The mixture solution was supplied into the chamber.

On the PMMA micro thrust apparatus, PTFE surface-treated using an ion beam process apparatus was adhered using an epoxy binder, after which tests for changes in the shape of the meniscus and electric spray were conducted.

The PTFE was processed to have a super-hydrophobic surface, after which an electric spray test was conducted. As the results, the operating voltage fell in the range from 3200 v to 5000 v.

At the operating voltage of 3200 v, the shape of the meniscus was changed to a Taylor Cone shape. Even when the voltage was increased, the meniscus and cone-jet shapes were stabilized, and the size and height of the cone jet were decreased. Thus, the size of droplets to be jetted by the electric spray was decreased, and stability was increased.

The PTFE surface nozzle without super-hydrophobic treatment had the operating voltage ranging from 3200 v to 5000 v (FIG. 10).

### CONCLUSION

As a result of processing the PTFE polymer for a super-hydrophobic nozzle surface using an ion beam process apparatus, when the process time was extended under conditions of 2 sccm of Ar, 3 sccm of O₂, and 1 keV, the surface became super-hydrophobic. Thereby, the surface energy was confirmed to be decreased through the ion beam apparatus. As a result of determining the change in contact angle every 24 hours for one week, it was confirmed that almost no change in contact angle occurred.

As a result of conducting the electric spray after the PTFE was processed to have the super-hydrophobic surface and then processed on the micro thrust apparatus, the operating voltage was confirmed to fall in the range from 3200 v to 5000 v. As the voltage was increased, the Taylor cone shape formed, and the size of the cone jet was decreased, and thus, the size of the droplets to be jetted was decreased and stabilization was realized.

As described hereinbefore, the present invention provides an apparatus for jetting droplets using a super-hydrophobic nozzle. According to the present invention, a side face of a body thereof is of super-hydrophobic, and thus, the initial formation of the meniscus of a fluid containing liquid and particles is effectively realized at the time of jetting using a nozzle, and the stability and efficiency of a jetting phenomenon are increased, even when the jetting process is repeated.

Further, the PTFE nozzle, surface-treated through an oxygen plasma process or an argon and oxygen ion beam process, causes no changes in the initial shape or position of the meniscus even when electric spray is repeated ten times or more, resulting in stable electric spray.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for jetting droplets using a super-hydrophobic nozzle, comprising a body including a chamber formed in the body to receive a predetermined amount of fluid containing liquid and particles and a nozzle formed in a side face of the body while communicating with the chamber to jet the fluid containing liquid and particles, and an actuator for generating an electric field so that the fluid containing liquid and particles is jetted through the nozzle, wherein the side face of the body is of super-hydrophobic.

2. The apparatus as set forth in claim 1, wherein the body is formed of polytetrafluoroethylene, and the side face of the body is formed into a super-hydrophobic surface through an oxygen plasma process or an argon and oxygen ion beam process.

3. The apparatus as set forth in claim 1, wherein the side face of the body is coated with Teflon, and the side face of the body, coated with Teflon, is formed into a super-hydrophobic surface through an oxygen plasma process or an argon and oxygen ion beam process.

4. The apparatus as set forth in claim 1, wherein the side face of the body is coated with a polytetrafluoroethylene solution, and the side face of the body, coated with the polytetrafluoroethylene solution, is formed into a super-hydrophobic surface through an oxygen plasma process or an argon and oxygen ion beam process.

5. The apparatus as set forth in claim 1, wherein the side face of the body includes a plurality of nozzles formed therein, which communicates with a plurality of chambers formed in the body, respectively.

6. The apparatus as set forth in claim 1, wherein the actuator comprises an electrode located in the chamber or the nozzle or deposited on a wall surface thereof, an electrode plate spaced apart from the side face of the body at a predetermined distance and having a jetting hole at a position corresponding to the nozzle, a power supply portion for applying voltage between the electrode and the electrode plate, and a control portion for controlling the power supply portion.

7. The apparatus as set forth in claim 6, wherein the electrode plate includes a plurality of electrode plates, which is disposed parallel to each other, and the nozzle includes a plurality of nozzles, which is independently controlled to form and jet the droplets.

8. A drop-on-demand inkjet apparatus using the apparatus of any one of claims 1 to 7, which is adapted to jet droplets at various time points at various frequencies in response to application of a pulse voltage signal.

9. A thrust apparatus using the apparatus of any one of claims 1 to 7.

10. An electrospray ionization apparatus using the apparatus of any one of claims 1 to 7, which is adapted for mass spectrometry.

11. An apparatus for jetting droplets using a super-hydrophobic nozzle, comprising a body including a chamber formed in the body to receive a predetermined amount of fluid containing liquid and particles and a nozzle formed in a side face of the body while communicating with the chamber to jet the fluid containing liquid and particles, and an actuator for generating an electric field so that the fluid containing liquid and particles is jetted through the nozzle, wherein the side face of the body is of super-hydrophobic, and the actuator comprises an electrode located in the chamber or the nozzle or deposited on a wall surface thereof, an electrode plate spaced apart from the side face of the body at a predetermined distance and having a jetting hole at a position corresponding to the nozzle, a power supply portion for applying voltage between the electrode and the electrode plate, and a control portion for controlling the power supply portion.
